(19) United States
(12) Patent Application Publication
(10) Pub. No.: US 2019/0279196 A1
(43) Pub. Date: Sep. 12, 2019

(54) SYSTEMS AND METHODS FOR DIGITIZING PAYMENT CARD ACCOUNTS

(71) Applicant: MASTERCARD INTERNATIONAL INCORPORATED, PURCHASE, NY (US)

(72) Inventors: Sneha Pendse, Parsippany, NJ (US); Claire Venot, Rambouillet (FR); Pedro Chavarria, Miami, FL (US); Joseph Hayes, Montclair, NJ (US)

(21) Appl. No.: 16/295,464

(22) Filed: Mar. 7, 2019

Related U.S. Application Data
(60) Provisional application No. 62/640,373, filed on Mar. 8, 2018.
(60) Provisional application No. 62/753,432, filed on Oct. 31, 2018.

(51) Int. Cl. G06Q 20/36; G06Q 20/06; G06Q 20/38

(52) U.S. Cl. CPC G06Q 20/3672; G06Q 20/3825; G06Q 20/0655; G06Q 20/363

(57) ABSTRACT

A payment card account holder interacts with his/her account issuer to trigger digitization of his/her payment account to a wallet service provider, a smart device, or a merchant, etc. The account issuer cooperates with an account provisioning service to fulfill the requested provisioning of the payment account to the desired recipient service provider/token requestor. The account issuer may also provision information about the account holder (e.g., contact information) to the service provider/token requestor.

### CROSS REFERENCE TO RELATED APPLICATION

This application claims the benefit of U.S. Provisional Patent Application Nos. 62/640,373 (filed on Mar. 8, 2018) and 62/753,432 (filed Oct. 31, 2018); the contents of which provisional applications are hereby incorporated by reference for all purposes.

### BACKGROUND

Payment card accounts are in widespread use. Payment cards and/or associated payment account numbers or payment tokens are frequently presented by consumers and businesses to pay for in-store purchase transactions, online shopping transactions, bill payments and other purposes.

One known manner for accessing a payment card account is by presenting a payment card or other device at a point of sale in a retail store. Other manners of accessing a payment card account are via a wallet service provider (WSP), or by having the account in a “card on file” status with an e-commerce merchant, or by associating the account with a smart device as part of the trend referred to as the “Internet of Things.” For each of these situations, a preliminary step involves “provisioning” or “digitizing” the card account to associate it with a user's digital wallet provided by WSP, or with a connected smart device, or with a merchant's e-commerce operations, or for storage in or access by a payment-enabled smartphone or the like.

According to a known approach for performing a provisioning operation (for example, in the WSP situation), the user contacts his/her WSP and requests that the provisioning occur. The WSP then contacts a provisioning service (e.g., Mastercard Digital Enablement Service or “MDES”, which is operated by the assignee hereof), which in turn contacts the account issuer. The account issuer (i.e., the financial institution that issued the payment card account to be provisioned) may in many cases then seek to authenticate the account holder prior to assenting to the provisioning request. This scenario has the disadvantage of requiring a second procedure to b e performed by the user. Moreover, circumstances frequently prevent the user authentication from being successfully performed, thus derailing the requested provisioning of the payment card account.

Moreover, according to some online transaction processes, users manually enter their payment account number, their account billing address, their email address and their phone number into a checkout page or pages downloaded to the user's computing device from the merchant's e-commerce server. However, it is sometimes the case that users find it too onerous to enter all this information. They may accordingly abandon online transactions before the transactions are complete, or refrain from engaging in online shopping because they do not wish to take on the task of data entry at checkout.

The present inventors have now recognized techniques for improving digitization of payment card accounts and also for improving the user's experience in connection with the checkout phase of an online shopping transaction.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram of a portion of a payment card account system according to some embodiments.

FIG. 2 is a block diagram of an example computer system that may perform functions in the system of FIG. 1.

FIG. 2A is a block diagram of another example computer system that may perform functions in the system of FIG. 1.

FIG. 3 is a simplified block diagram of an example of a typical mobile device that may be employed by a user of the system of FIG. 1.

FIGS. 4, 5 and 6 are flow charts that illustrate processes that may be performed in the system of FIG. 1 in accordance with aspects of the present disclosure.

### DESCRIPTION

In general, and for the purpose of introducing concepts of embodiments of the present disclosure, a user contacts the account issuer to initiate provisioning of a payment card account issued by the issuer to the user. The user performs a log-in/authentication procedure with the issuer, and thereafter is not required to perform further user authentication by the issuer. The user then selects a recipient (token requestor) for the account(s) to be provisioned and selects the account(s) to be provisioned. Interactions thereafter occur among the token requestor, a provisioning service and the issuer to complete the provisioning request. According to one feature of this process, the provisioning request is identified via a one-time only identifier such that the funding primary account number (FPAN) of the account to be provisioned need not be communicated to the token requestor, thereby enhancing the security of the provisioning process.

Furthermore, in other embodiments, account issuers push cardholder information to token requestors such as merchants, remote commerce services and wallet service providers (WSPs). This may occur in tandem with pushing of payment tokens and related payment credential information to such information recipients (token requestors). The cardholder information may include cardholder name, email address, account billing address and/or one or more phone numbers. By being in receipt of this information, the information recipients may be in a position to automatically populate user information screens to ease customers' process of registering and/or transacting with the information recipient or with other parties. Consequently, the overall user experience connected with e-commerce may be improved.

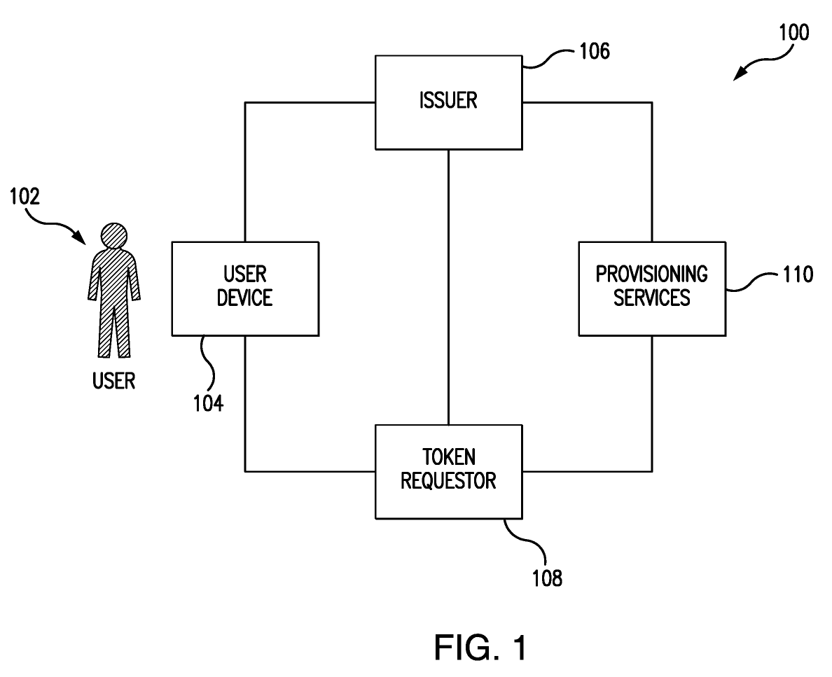

FIG. 1 is a block diagram of a portion of a payment card account system 100 according to some embodiments. In particular, FIG. 1 shows the parties to a provisioning request; those parties include a user 102 operating a user device 104, an account issuer 106, a token requestor 108 and a provisioning services entity 110. As will be inferred from earlier discussion, the token requestor 108 may be a WSP, an e-commerce merchant, or a smart device with which the provisioned payment card account is to be associated, among other possibilities. In some scenarios (e.g., provisioning the payment card account to the user device 104), the token requestor may be the user device 104 or a relevant app on the user device 104.

In subsequent discussion and/or in the appended claims, “token requestor” and “service provider” will be used interchangeably. Thus “service provider” is not limited to WSPs.

The user device 104 may be a smartphone or other mobile device, a personal computer, or other intelligent device capable of data communication with remote server computers.

It will be seen that the user device 104 may be in communication with the issuer 106 and the token requestor 108 in connection with the provisioning request. Each of the issuer 106, the token requestor 108 and the provisioning services entity 110 may be in communication with the other two of the three parties mentioned in this sentence in connection with the provisioning request.

The parties shown in FIG. 1 should be thought of as part of a larger system, including a payment card account network, numerous issuers of card accounts, a very large number of merchants that accept card account transactions and financial institutions that serve the merchants by performing acquiring services with respect to the card account transactions. Other participants in the system include the millions of individuals and organizations that are holders of card accounts and who use payment cards or payment-enabled devices to initiate card account transactions, while also potentially accessing their card accounts in other manners. Many issuers and a very large number of users and token requestors may play the roles shown in FIG. 1.

Any one or more of the blocks shown in FIG. 1, in addition to representing the indicated entity, may also be considered to represent one or more computer systems operated by such entity.

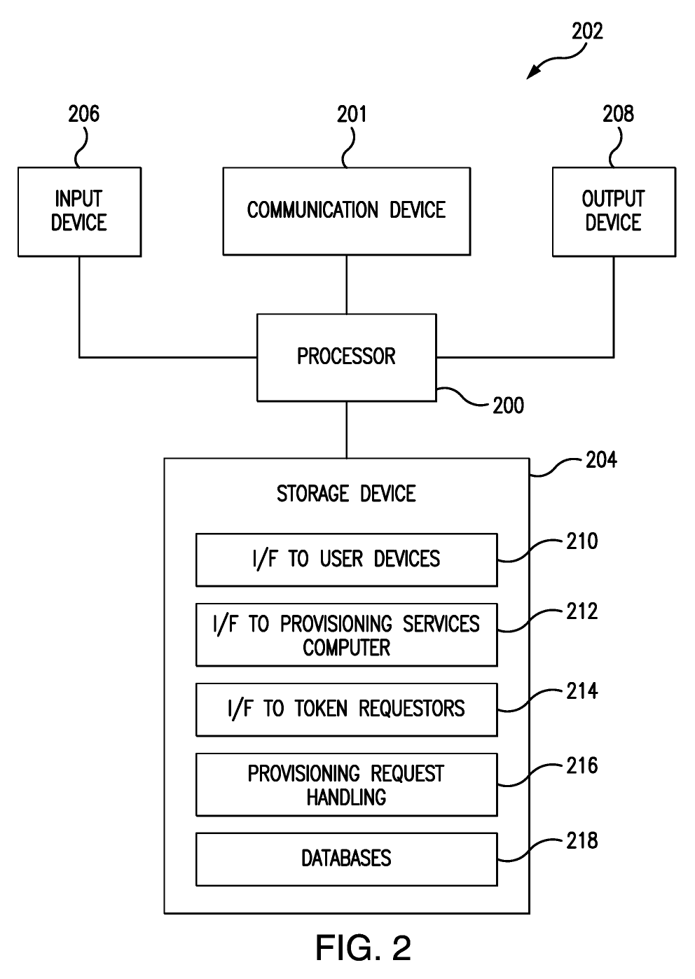

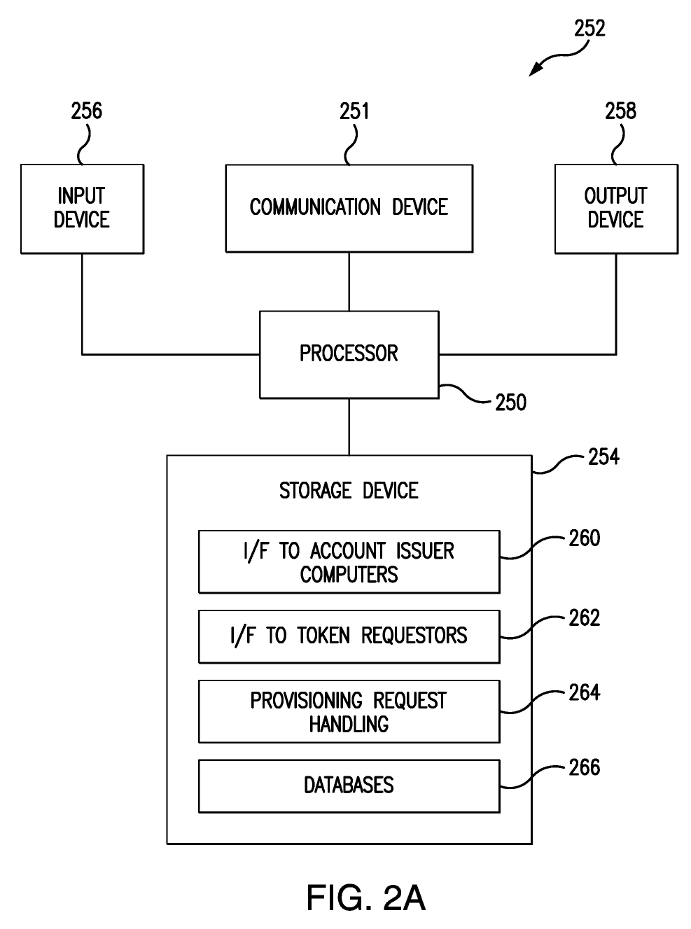

FIG. 2 is a block diagram of an account issuer computer system 202 that may perform the functions of the account issuer 106 shown in FIG. 1 with respect to provisioning requests. The account issuer computer system 202 may, in its hardware aspects, resemble a typical mainframe computer, but may be controlled by software to cause it to function as described herein.

Referring to FIG. 2, the account issuer computer system 202 may include a computer processor 200 operatively coupled to a communication device 201, a storage device 204, an input device 206 and an output device 208. The communications device 201, the storage device 204, the input device 206 and the output device 208 may all be in communication with the processor 200.

The computer processor 200 may be constituted by one or more processors. Processor 300 operates to execute processor-executable steps, contained in program instructions described below, so as to control the account issuer computer system 202 to provide desired functionality.

Communication device 201 may be used to facilitate communication with, for example, other devices (such as other components of the payment transaction system 100, as well as numerous devices operated by users of the system 100). Communication device 201 may comprise numerous communication ports (not separately shown), to allow the account issuer computer system 202 to communicate simultaneously with a large number of other devices, including communications as required to simultaneously participate in handling numerous provisioning requests.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of the account issuer computer system 202, executed by the processor 200 to cause the account issuer computer system 202 to function as described herein.

The programs may include one or more conventional operating systems (not shown) that control the processor 200 so as to manage and coordinate activities and sharing of resources in the account issuer computer system 202, and to serve as a host for application programs (described below) that run on the account issuer computer system 202.

The storage device 204 may also store a software interface 210 that facilitates communication between the account issuer computer system 202 and devices operated by users of the system 100. In addition, the storage device 204 may store a software interface 212 that facilitates communication between the account issuer computer system 202 and a computer operated by the provisioning services entity 110.

Further, the storage device 204 may store a software interface 214 that facilitates communication between the account issuer computer system 202 and token requestors such as the entity 108 shown in FIG. 1.

The programs stored in the storage device 204 may further include, for example, a provisioning request handling application program 216. The provisioning request handling application program 216 may operate to handle provisioning requests in a manner or manners to be described below.

The storage device 204 may also store, and the account issuer computer system 202 may also execute, other programs, which are not shown. For example, such programs may include communications software and a reporting application. The latter program may respond to requests from system administrators for reports on the activities performed by the account issuer computer system 202. The other programs may also include, e.g., device drivers, database management software, website hosting software, etc.

The storage device 204 may also store one or more databases 218 needed for operation of the account issuer computer system 202. The databases 218 may include a database referred to below that stores data concerning potential token requestors for the users served by the account issuer computer system 202.

Respective computers operated by the token requestor and the provisioning services entity may have a similar hardware architecture and/or hardware components as described above in connection with FIG. 2. Each of the latter computers may be programmed with suitable provisioning request handling software such that those computers perform functionality as described herein.

FIG. 2A is a block diagram of a provisioning service computer system 252 that may perform the functions of the provisioning services entity 110 shown in FIG. 1 with respect to provisioning requests. The provisioning service computer system 252 may have the same hardware architecture and components as described above in connection with FIG. 2. Thus the provisioning service computer system 252 may include a computer processor 250 operatively coupled to and in communication with a communication device 251, a storage device 254, an input device 256 and an output device 258.

Storage device 254 stores one or more programs for controlling processor 250. The programs comprise program instructions (which may b e referred to as computer readable program code means) that contain processor-executable process steps of the provisioning service computer system 252, executed by the processor 250 to cause the provisioning service computer system 252 to function as described herein.

The programs may include one or more conventional operating systems (not shown) that control the processor 250 so as to manage and coordinate activities and sharing of resources in the provisioning service computer system 252, and to serve as a host for application programs (described below) that run on the provisioning service computer system 252.

The storage device 254 may also store a software interface 260 that facilitates communication between the provisioning service computer system 252 and account issuer computers. In addition, the storage device 254 may store a software interface 262 that facilitates communication between the provisioning service computer system 252 and devices that are operated by or are token requestors/service providers.

The programs stored in the storage device 254 may further include, for example, a provisioning request handling application program 264. The provisioning request handling application program 264 may operate to handle provisioning requests (in cooperation with account issuers) in a manner or manners to be described below.

The storage device 254 may also store, and the provisioning service computer system 252 may also execute, other programs, which are not shown. For example, such programs may include communications software and a reporting application. The latter program may respond to requests from system administrators for reports on the activities performed by the provisioning service computer system 252. The other programs may also include, e.g., device drivers, database management software, etc.

The storage device 254 may also store one or more databases 266 needed for operation of the account issuer computer system 202.

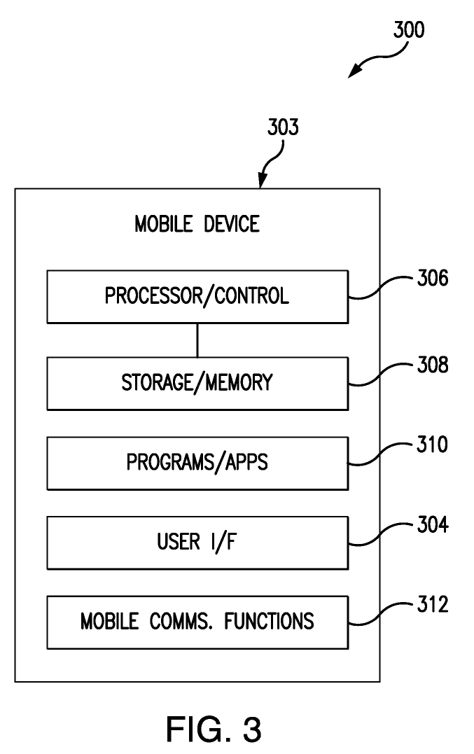

FIG. 3 is a simplified block diagram of an example of a typical mobile device 300 that may be employed as the user device 104 shown in FIG. 1.

The mobile device 300 may include a housing 303. In many embodiments, the front of the housing 303 is predominantly constituted by a touchscreen (not separately shown), which is a key element of the user interface 304 of the mobile device 300.

The mobile device 300 further includes a mobile processor/control circuit 306, which is contained within the housing 303. Also included in the mobile device 204 is a storage/memory device or devices (reference numeral 308). The storage/memory devices 308 are in communication with the processor/control circuit 306 and may contain program instructions to control the processor/control circuit 306 to manage and perform various functions of the mobile device 300. As is well-known, a device such as mobile device 300 may function as what is in effect a pocket-sized personal computer (assuming for example that the mobile device is a smartphone), via programming with a number of application programs, or “apps”, as well as a mobile operating system (OS). (In general, the apps are represented at block 310 in FIG. 3, and may, along with other programs, in practice be stored in block 308, to program the processor/control circuit 306.)

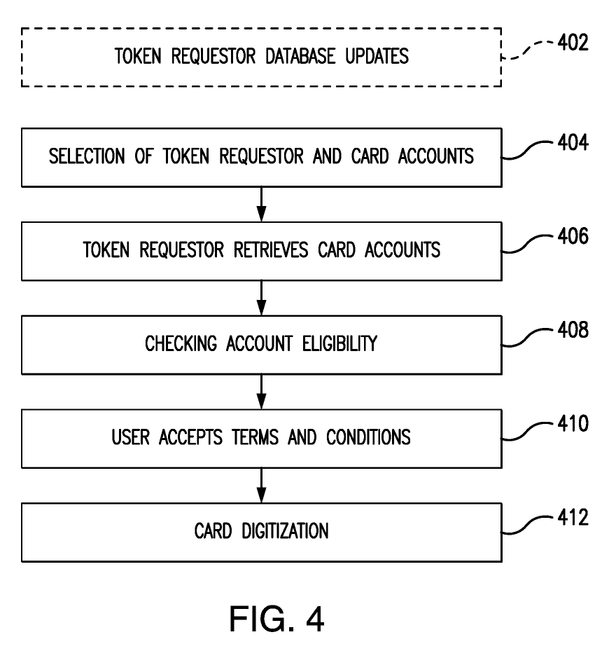

The apps 310 may include one or more apps referred to below in connection with FIG. 4, and may include an app supplied by the issuer of the user's payment card account(s) and an app supplied by the user's WSP.

As is typical for mobile devices, the mobile device 300 may include mobile communications functions as represented by block 312. The mobile communications functions may include voice and data communications via a mobile communication network with which the mobile device 300 is registered.

From the foregoing discussion, it will be appreciated that the blocks depicted in FIG. 3 as components of the mobile device 300 may in effect overlap with each other, and/or there may be functional connections among the blocks which are not explicitly shown in the drawing. It may also be assumed that, like a typical smartphone, the mobile device 300 may include a rechargeable battery (not shown) that is contained within the housing 303 and that provides electrical power to the active components of the mobile device 300.

It has been posited that the mobile device 300 may be embodied as a smartphone, but this assumption is not intended to be limiting, as mobile device 300 may alternatively, in at least some cases, be constituted by a tablet computer or by other types of mobile computing devices. It is also noted that the user device 104 of FIG. 1 need not be a mobile device.

FIG. 4 is a flow chart that illustrates a process of payment card account provisioning that may be performed in the system 100 according to aspects of the present disclosure.

Block 402 in FIG. 4 represents updates of a database at the issuer 106, where the database holds records relating to a population or list of potential token requestors available for selection by the user for a provisioning request. Block 402 is in phantom to indicate that it may occur on a repeating (say, daily) or ongoing fashion so that the issuer 106 is kept up to date on the available token requesters for all of its account holders.

As a substep to block 402, the issuer 106 may send a request message to the provisioning services entity 110 to request an update on available token requestors. As noted above, the token requestors available to the user may include one or more WSPs, one or more types of smart devices, e-commerce merchants and/or one or more mobile devices operated by the user, among other possibilities. The provisioning services entity 110 may respond to the request message from the issuer 106 by providing a data feed to update the issuer's database, including possibly removing formerly potential token requestors that are no longer applicable to a given user. The exchange of data messages between the issuer 106 and the provisioning services entity 110 may, in some embodiments, include a request from the issuer 106 to the provisioning services entity 110 for logos or other images to visually identify to the user potential token requestors newly added to the issuer's database record for the user.

To provide a few examples, the provisioning services entity 110 may have access to the user's smartphone to scan it for new apps. In doing such a scan, the provisioning services entity 110 may detect that the user's smartphone has had installed an app for a fitness-tracking wristband. During the next update of the issuer's database record for the user, the provisioning services entity 110 may provide to the issuer 106 data that identifies the distributor of the fitness-tracking wristband in question, as well as an image of the wristband and/or the logo of the distributor of the wristband.

In another example, the provisioning services entity 110 may detect that the user's smartphone has added a new WSP app. During the next update of the issuer's database record for the user, the provisioning services entity 110 may provide to the issuer 106 data that identifies the WSP in question, as well as an image that corresponds to the WSP's logo.

Block 404 in FIG. 4 may be taken as the start of handling a particular provisioning request or related provisioning requests from the user 102.

At block 404, the user 102 operates the user device 104 to open communications with the issuer 106. This may involve the user 102 opening an app on the user device 104 that has previously been downloaded by the issuer 106 to the user device 104. Alternatively, the user 102 may use the browser on the user device 104 to access the issuer's customer service webpage. It may be assumed that the user successfully logs in to the issuer's computer, including for example a user authentication step such as entering a PIN (personal identification number). It will further be assumed that the user's intention is to have one or more card accounts previously issued to him/her by the issuer 106 to be provisioned to the user's WSP (which will be the token requestor 108 in this scenario). The issuer discloses to the user eligible token requestors and eligible cards. The user selects from among the eligible token requestors—it will be assumed for this example that only one token requestor is selected. It will also be assumed that only one card account is selected.

The issuer provides information about the selected token requestor and the selected card account to the provisioning services entity. The issuer also provides an electronic signature (TAV) to the provisioning services entity. The provisioning services entity verifies the electronic signature and generates a request receipt that it provides to the issuer. The request receipt may be in any format, and need not be in a token or PAN format. The request receipt will—later in the process—be used to identify the request for completion of the requested provisioning. The request receipt may serve to stand in for the account number that corresponds to the selected card account.

At 406, the token requestor retrieves the requested card account(s) (assumed to be one account for present purposes. As a substep to 406, the issuer sends information including the request receipt to the token requestor. The token requestor contacts the user to request that the user log-in with the token requestor (assumed to be the user's WSP in this example). The user logs in (submitting a required PIN or other credentials).

At 408, the eligibility of the requested card account is checked. As a substep to 408, the token requestor sends a request for an eligibility check to the provisioning services entity. The request for eligibility check includes the provisioning request receipt. The provisioning services entity may check the eligibility with the issuer. The provisioning services entity may indicate to the token requestor that the requested card account is eligible for provisioning to the token requestor.

At 410, the user accepts relevant terms and conditions. As a substep to 410, the token requestor obtains terms and conditions information from the provisioning services entity. The token requestor presents the terms and conditions to the user, who accepts the terms and conditions.

At 412, the card digitization is performed (i.e. the provisioning of the card account to the token requestor takes place). (In a case where more than one card account was selected for provisioning, this step is repeated.) As a substep to 412, the token requestor may request digitization of the card account from the provisioning services entity. This request may include an eligibility receipt that identifies the card account (e.g. via the above-mentioned request receipt.) The provisioning services entity may validate the request from the token requestor, including validation of an electronic signature (TAV). The provisioning services entity may send a token authorization request to the issuer. The issuer may approve the token authorization request. In many or most cases, the authorization to issue a token may follow the so-called “green path”—i.e., without requiring further user authentication—rather than the “yellow path”. This may assume validation of the electronic signature and issuer parameterization of the applicable rule. The provisioning services entity may then issue the token (mapped to the card account) to the token requestor. The token requestor may confirm to the issuer that the card account (via the token) has been loaded to the token requestor.

By representing the requested provisioning with the request receipt, and passing the request receipt from the provisioning services entity to the account issuer to the token requestor and back to the provisioning services entity, circulation of more sensitive data, such as an FPAN, is limited and the provisioning process is made more secure. Moreover, once the account holder is initially logged-in with the account issuer, this may be sufficient authentication for the account holder, and no further authentication of the account holder to the account issuer may be required. This may result in an improved user experience and a greater likelihood that the requested provisioning will be completed.

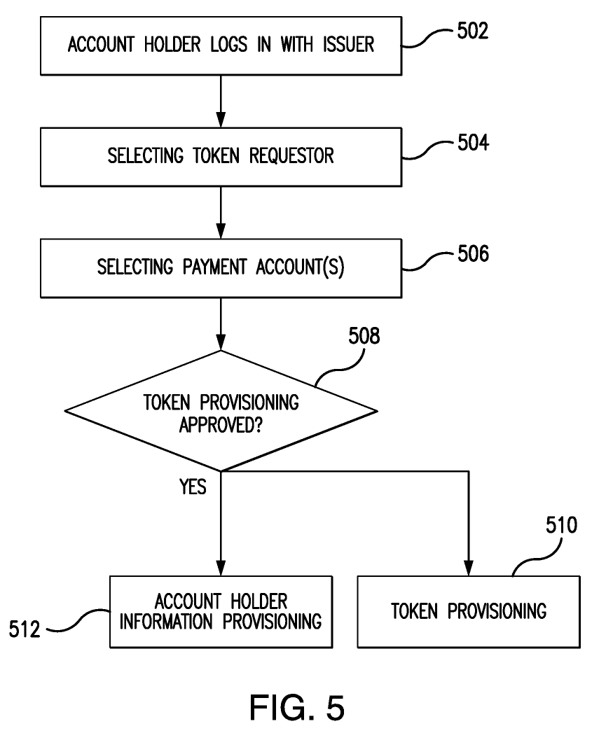

FIG. 5 is a flow chart that illustrates a further process for payment card account provisioning that may be performed in the system 100 according to aspects of the present disclosure.

At 502 in FIG. 5, the user 102 operates his/her user device 104 to log in with the account issuer 106 on the issuer's website (not separately shown). It will be appreciated that this may involve the user device 104 and the account issuer computer system 202 interacting with each other via the internet (not shown) and/or one or more mobile communication networks (not shown) and/or via one or more other communication channels (not shown apart from channel 112 shown in FIG. 1). In contacting the account issuer, the user 102 may use a mobile banking application on the user device 104; alternatively, the interaction with the account issuer 106 may be via a mobile browser on the user device 104. As part of the log-in procedure, user authentication may be carried out to assure the issuer 106 that the person logging in is who he/she claims to be. This may involve entry of a password known only to the user 102 and the issuer 106 and/or other suitable steps, including a one-time password and/or a challenge to and response from the user device 104.

The balance of FIG. 5 assumes that the user 102 has elected a payment account provisioning function from a number of options available to the user after log-in.

At 504, the user 102 utilizes the user device 104 to interact with the account issuer computer system 202 to select the token requestor 108 as the entity to which one or more of the user's payment accounts are to be provisioned. At 506, the user 102 utilizes the user device 104 to interact with the account issuer computer system 202 to select one or more of the user's payment accounts issued by the issuer 106, with the selected account(s) to be provisioned to the token requestor 108.

Following block 506 in FIG. 5 is a decision block 508. At decision block 508, the account issuer computer system 202 may determine whether to approve the payment account provisioning as requested by the user 102. This determination may include the account issuer computer system 202 determining whether the requested payment account(s) is (are) eligible for provisioning and whether the requested token requestor is eligible to receive the requested payment account(s). The account issuer computer system 202 may also check whether there are any other problems that disqualify the requested provisioning.

On the assumption that the account issuer computer system 202 approves the provisioning request, blocks 510 and 512 may follow decision block 508. At block 510, payment token provisioning (including provisioning of related payment credential information) may occur. This may be done in a manner described hereinabove in connection with FIG. 4.

At block 512, the account issuer computer system 202 provisions (pushes) cardholder information to the token requestor 108.

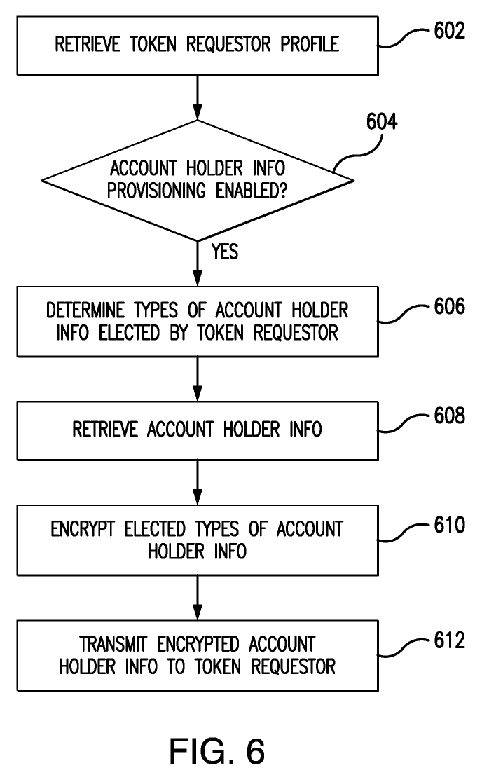

FIG. 6 is a flow chart that illustrates details of the processing involved in carrying out the cardholder information provisioning; FIG. 6 will now be discussed.

At block 602 in FIG. 6, the account issuer computer system 202 retrieves a profile or data entry for the token requestor 108 (i.e. for the token requestor selected at 504 in FIG. 5). The retrieval of the token requestor profile may be internal to the account issuer computer system 202, or, as one alternative, may be from the provisioning services entity 110 (FIG. 1).

In the process of FIG. 6, a decision block 604 may follow block 602. At decision block 602, the account issuer computer system 202 may make a determination (based on the token requestor profile retrieved at 602) as to whether the circumstances are such that provisioning of cardholder information is enabled for the token requestor 108. This, in turn, may involve the account issuer computer system 202 determining whether the token requestor 108 has indicated that it wishes to receive cardholder information. This may further involve determining whether, according to the policies or decisioning of the issuer 106, the token requestor 108 has been qualified by the issuer 106 to receive cardholder information.

Assuming that the account issuer computer system 202 determines at decision block 604 that cardholder information provisioning is enabled for the token requestor 108, then block 606 may follow decision block 604. At 606, the account issuer computer system 202 may determine, from the token requestor profile retrieved at 602, what type or types of cardholder information are to be provided to the token requestor 108. For example, in one embodiment, where the token requestor 108 is a remote commerce service (e.g., an SRC, or secure remote commerce service), the token requestor may be determined to receive only the account billing address, the cardholder email address, and the cardholder mobile phone number. In another example, the token requestor may receive the three types of information just listed, and also may receive the cardholder's name (first and last names) and the cardholder landline phone number. In other embodiments, there may be further variations and/or additions in the types of cardholder information pushed from the account issuer computer system 202 to the token requestor 108. The types of cardholder information supplied may, in some embodiments, be in accordance with a selection of types of cardholder information indicated by the token requestor 108 in connection with a pre-arrangement between the token requestor 108 and the issuer 106 or via a pre-arrangement between the token requestor 108 and the provisioning services entity 110.

In some arrangements, the token requestor 108 may commit itself not to use the cardholder information received from the account issuer computer system 202 for any purpose other than creating or updating a user account. In some arrangements, an exception to the commitment referred to in the previous sentence may occur only if and when the token requestor 108 requests and receives explicit permission from the user/account holder/cardholder to use the cardholder information for another purpose or purposes.

Continuing to refer to FIG. 6, block 608 may follow block 606. At block 608, the account issuer computer system 202 retrieves, from the data profile/data entry for the user, the information corresponding to the types of information determined at 606.

Block 610 may follow block 608. At block 610, the account issuer computer system 202 may encrypt the cardholder/account holder/user information retrieved at 608.

Block 612 may follow block 610. At block 612, the account issuer computer system 202 may transmit the encrypted information to the token requestor 108. In some embodiments, the account issuer computer system 202 may push the cardholder information directly to the token requestor 108. In other embodiments, the transmission of cardholder information from the account issuer computer system 202 to the token requestor 108 may be via the provisioning services entity 110 (FIG. 1).

With the cardholder information provided to it at 612, the token requestor 108 may be enabled to prepopulate fields with the information to improve the user's experience in signing up or logging in or transacting with the token requestor 108 (or with an e-commerce merchant, in the case where the token requestor 108 is an SRC). In one embodiment, in response to receiving the cardholder information, the token requestor may send a prompt to the user device 104 (using, e.g., a mobile phone number supplied at 612) to prompt the user to engage in a sign-up process with the token requestor 108. The token requestor may be enabled to piggyback on the user authentication performed by the issuer 106 in connection with the provisioning request.

According to other aspects of this disclosure, a life cycle event for a payment account/token may be accommodated. For example, an account holder may request a new FPAN from an account issuer. The account issuer may send an old/expiring token and the new FPAN to the provisioning service entity. The provisioning service entity may send the new FPAN or new token to a service provider such as a merchant having a card-on-file arrangement with the account holder. The service provider may update its card-on-file information accordingly.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The above descriptions and illustrations of processes herein should not be considered to imply a fixed order for performing the process steps. Rather, the process steps may be performed in any order that is practicable, including simultaneous performance of at least some steps and/or omission of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” and “card account” are used interchangeably herein. The term “payment card account number” includes a number that identifies a payment card system account or a number carried by a payment card, or a number that is used to route a transaction in a payment system that handles payment card transactions. The term “payment card” includes a credit card, debit card, prepaid card, or other type of payment instrument, whether an actual physical card, electronic, or virtual.

As used herein and in the appended claims, the term “payment card system” or “payment account system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific example embodiments, it should be understood that various changes, substitutions, and alterations apparent to those skilled in the art can be made to the disclosed embodiments without departing from the spirit and scope of the disclosure.

What is claimed is:

1. A method comprising:
receiving, in an account issuer computer, a log-in request from an account holder;
logging-in the account holder to the account issuer computer;
prompting the account holder to select from among a plurality of service providers for receiving provisioning of payment account digitization;
receiving from the account holder, in the account issuer computer, a selection indication, said selection indication indicating selection of one of the plurality of service providers;
transmitting, from the account issuer computer to a provisioning service computer, information that identifies (a) the selected one of the service providers, and (b) a payment account to be provisioned to the selected one of the service providers, said payment account owned by the account holder;
receiving, by the account issuer computer, from the provisioning service computer, a request receipt,
transmitting the request receipt, from the account issuer computer, to the selected one of the service providers;
receiving, by the account issuer computer, from the provisioning service computer, a token authorization request; and
transmitting, from the account issuer computer to the provisioning service computer, an indication that the account holder approves the received token authorization request.

2. The method of claim 1, further comprising:
receiving, by the account issuer computer, a confirmation that the payment account has been provisioned to the selected one of the service providers.

3. The method of claim 1, further comprising:
generating an electronic signature that authenticates the account issuer computer; and
transmitting the electronic signature from the account issuer computer to the provisioning service computer, the electronic signature transmitted together with said information that identifies the payment account and the selected one of the service providers.

4. The method of claim 1, wherein said plurality of service providers are listed in a list of eligible service providers maintained in the account issuer computer.

5. The method of claim 4, further comprising:
receiving, in the account issuer computer, updates to the list of eligible service providers.

6. The method of claim 1, further comprising:
receiving, by the account issuer computer from the provisioning service computer, an inquiry as to whether the payment account is eligible for provisioning to the selected one of the service providers.

7. The method of claim 6, further comprising:
transmitting, in response to said inquiry, from the account issuer computer to the provisioning service computer, an indication that the payment account is eligible for provisioning to the selected one of the service providers.

8. The method of claim 1, wherein the information that identifies (a) the selected one of the service providers, and (b) the payment account to be provisioned to the selected one of the service providers is transmitted in encrypted form from the account issuer computer to the provisioning service computer.

9. A method comprising:
receiving, by a provisioning service computer, from an account issuer computer, information that identifies (a) a service provider; and (b) a payment account to be provisioned to the service provider;
generating, by the provisioning service computer, a request receipt;
transmitting the request receipt from the provisioning service computer to the account issuer computer;
receiving, by the provisioning services computer from the service provider, the request receipt;
transmitting, from the provisioning service computer to the account issuer computer, a token authorization request;
receiving, by the provisioning service computer from the account issuer computer, an indication that the account issuer computer approved the token authorization request; and
in response to said indication, issuing a payment token by the provisioning service computer to the service provider.

10. The method of claim 9, further comprising:
transmitting, by the provisioning services computer to the account issuer computer, a confirmation that the payment account has been provisioned to the service provider.

11. The method of claim 9, further comprising:
receiving an electronic signature, by the provisioning service computer, from the account issuer computer, said electronic signature received together with the information that identifies the service provider and the payment account, said electronic signature authenticating the account issuer computer.

12. The method of claim 11, further comprising:
the provisioning services computer verifying the received electronic signature.

13. The method of claim 12, wherein the provisioning services computer generates said request receipt after said verifying step.

14. The method of claim 9, further comprising:
transmitting, by the provisioning service computer to the account issuer computer, an inquiry as to whether the payment account is eligible for provisioning to the service provider.

15. The method of claim 14, further comprising:
receiving, by the provisioning service computer from the account issuer computer, an indication that the payment account is eligible for provisioning to the service provider.

16. The method of claim 15, further comprising:
transmitting, by the provisioning service computer to the service provider, an indication that the payment account is eligible for provisioning to the service provider.

17. The method of claim 9, wherein the information that identifies (a) the service provider;
and (b) the payment account to be provisioned to the service provider is received in encrypted form by the provisioning service computer.

18. A method comprising:
receiving, by an account issuer computer, from an account holder, a request to provision a payment token to a token requestor, the payment token for pointing to a payment account that belongs to the account holder;
determining, for the token requestor, types of account holder information the token requestor elects to receive;
based on a result of the determining step, provisioning elected account holder information to the token requestor, the elected account holder information including at least one of: (a) the account holder's name; (b) a billing address for the payment account; (c) the account holder's email address; (d) the account holder's mobile phone number; and (c) the account holder's landline phone number.

19. The method of claim 18, further comprising:
prior to said determining step, determining that provisioning of account holder information is enabled for the token requestor.

20. The method of claim 19, wherein said step of determining that provisioning of account information is enabled includes determining that the token requestor wishes to receive account holder information.

21. The method of claim 19, wherein said step of determining that provisioning of account information is enabled includes determining that an operator of the account issuer computer has qualified the token requestor to receive account holder information.

22. The method of claim 18, wherein the elected account holder information includes (i) a billing address for the payment account; (ii) the account holder's email address; and (iii) the account holder's mobile phone number.
